(19) United States
(12) Patent Application Publication
(10) Pub. No.: US 2004/0245670 A1
(43) Pub. Date: Dec. 9, 2004

(54) Method of forming a low tack elastomeric article

(76) Inventors: Robert A. Janssen, Alpharetta, GA (US); Martin S. Shamis, Alpharetta, GA (US); William E. Conley, Alpharetta, GA (US); Sanford E. White, Kennesaw, GA (US)

Correspondence Address: KIMBERLY-CLARK WORLDWIDE, INC., 401 NORTH LAKE STREET, NEENAH, WI, 54956

(21) Appl. No.: 10/454,703

(22) Filed: Jun. 3, 2003

(51) Int. Cl. B29C 41/14; B29C 41/42; B29C 71/02

(52) U.S. Cl. 264/236; 264/301; 264/304; 264/334

(57) ABSTRACT

A method of forming an elastomeric article includes providing a former, coating the former with a coagulant composition including zinc stearate, dipping the former into a polymer composition including an elastomeric polymer and water, curing the elastomeric polymer at a temperature above the melting point of the zinc stearate, and removing the water from the polymer composition on the former to form the elastomeric article.

### BACKGROUND OF THE INVENTION

Elastomeric gloves, such as surgical and examination gloves, have traditionally been made from natural or synthetic elastomers to provide a combination of good elasticity and strength. Due to their tight fit over the hand, however, elastomeric gloves are often difficult to don. To overcome this problem, powdered lubricants have been traditionally applied to the inside surface of the glove to reduce friction between the skin and the glove. Unfortunately, the use of powdered lubricants may not be appropriate for specific situations, such as the case of surgical gloves. Specifically, if some of the powder escapes from the inside of the glove into the surgical environment, as for example if the glove is torn during the surgery, the powder may enter the surgical wound and cause further complications for the patient.

As a result, other techniques have been developed to aid in the donning of elastomeric gloves. For example, the surface of natural rubber latex gloves has been chlorinated to reduce friction between the wearer-contacting surface and a user's skin when donned. Although chlorination significantly improves the donning characteristics of many gloves, other properties of the glove are sometimes adversely affected. For instance, when chlorinated, the outside, or gripping, surface of natural rubber gloves become slippery because the inside and outside surfaces of the glove are simultaneously chlorinated in an immersion apparatus. As a result, a user wearing such a glove may experience difficulty in gripping and/or handling objects. As such, a need exists for an elastomeric glove that is able to achieve good gripping characteristics, even when chlorinated.

### SUMMARY OF THE INVENTION

The present invention generally relates to a method of forming an elastomeric article. The method includes providing a former on which the article is to be formed, coating the former with a coagulant composition including zinc stearate, dipping the former into a polymer composition including an elastomeric polymer and water, curing the elastomeric polymer at a temperature above the melting point of the zinc stearate, and removing the water from the polymer composition on the former to form the elastomeric article. The zinc stearate may be present in the coagulant composition in any suitable amount, and in some instances, may be present in an amount of from about 0.5 mass % to about 8 mass % of the coagulant composition. In other instances, the zinc stearate may be present in the coagulant composition in an amount of from about 0.75 mass % to about 6 mass % of the coagulant composition. In other instances, the zinc stearate may be present in the coagulant composition in an amount of about 2 mass % of the coagulant composition. In yet other instances, the zinc stearate may be present in the coagulant composition in an amount of about 0.8 mass % of the coagulant composition.

The present invention further relates to a method of forming an elastomeric article having reduced tack. The method includes providing a former, coating the former with a coagulant composition including zinc stearate, dipping the former into a polymer composition including an elastomeric polymer and water, curing the elastomeric polymer, where curing the elastomeric polymer includes exposing the elastomeric polymer to a heat source having a first temperature zone maintained at a temperature of from about 120° C. to about 150° C., and a second temperature zone maintained at a temperature of from about 100° C. to about 119° C., and removing the water from the polymer composition on the former to form the elastomeric article.

The present invention also relates to a method of forming an elastomeric article having improved release characteristics. The method includes providing a former, coating the former with a coagulant composition including from about 0.5 mass % to about 8 mass % zinc stearate, dipping the former into a polymer composition including an elastomeric polymer and water, curing the elastomeric polymer, where curing the elastomeric polymer includes exposing the elastomeric polymer to a heat source having a first temperature zone maintained at from about 120° C. to about 150° C., a second temperature zone maintained at from about 111° C. to about 119° C., and a third temperature zone maintained at from about 105° C. to about 115° C., removing the water from the polymer composition on the former to form the elastomeric article, and stripping the elastomeric article from the former.

The present invention also relates to an elastomeric article formed by the method including providing a former, coating the former with a coagulant composition including about 0.8 mass % zinc stearate, dipping the former into a polymer composition including a nitrile butadiene rubber and water, curing the nitrile butadiene rubber at a temperature above the melting point of the zinc stearate, and removing the water from the polymer composition on the former to form the elastomeric article.

The present invention further relates to an elastomeric article formed by the method including providing a former, coating the former with a coagulant composition including about 2 mass % zinc stearate, dipping the former into a polymer composition including natural rubber and water, curing the natural rubber, where curing the natural rubber includes exposing the natural rubber to a heat source having a first temperature zone maintained at a temperature of from about 120° C. to about 150° C., and a second temperature zone maintained at a temperature of from about 100° C. to about 119° C., and removing the water from the polymer composition on the former to form the elastomeric article.

### BRIEF DESCRIPTION OF THE DRAWINGS

FIG. 1 is a scanning electron micrograph of the outside surface of a glove formed according to the present invention.

FIG. 2 is a scanning electron micrograph of the outside surface of a glove formed according to traditional techniques.

FIG. 3 is a perspective view of an elastomeric article, namely a glove, that may be formed according to the present invention;

FIG. 4A is a schematic cross-sectional illustration of the article of FIG. 3 taken along a line 4-4, the article including a substrate body and a donning layer; and

FIG. 4B is another schematic cross-sectional illustration of the article of FIG. 3 taken along a line 4-4, the article including a substrate body, a donning layer, and a lubricant layer.

### DESCRIPTION OF THE INVENTION

The present invention generally relates to a method of forming an elastomeric article having improved release characteristics and low tack, and an article formed according to such a method. As used herein, the term “elastomeric article” refers to an article formed predominantly from an elastomeric polymer. As used herein, the term “elastomeric polymer” refers to a polymeric material that is capable of being easily stretched or expanded, and will substantially return to its previous shape upon release of the stretching or expanding force.

The method of the present invention generally results in the formation of an elastomeric article, for example, a glove, that is easily stripped from the equipment on which it is formed and exhibits low surface tack on the outside surface of the article, and therefore, improved gripping characteristics. Traditionally, gloves have been formed using calcium carbonate in the coagulant to aid in the release of the glove from the former. However, the excess calcium carbonate needed to be removed through an additional post-formation rinsing step. Some efforts have been made to use zinc stearate as a replacement for the calcium carbonate; however, additional rinsing is still needed to remove excess particles. Furthermore, the zinc stearate particles tend to flake off over time, leaving an unsightly and unhygienic particulate residue on the hands and clothing of the wearer.

The method of the present invention eliminates the need for such costly and cumbersome post-processing by physically incorporating the zinc stearate into the materials used to form the article. Furthermore, the resulting article offers improved aesthetic properties, as no powder or dust flakes off the article onto the wearer's hands or clothing.

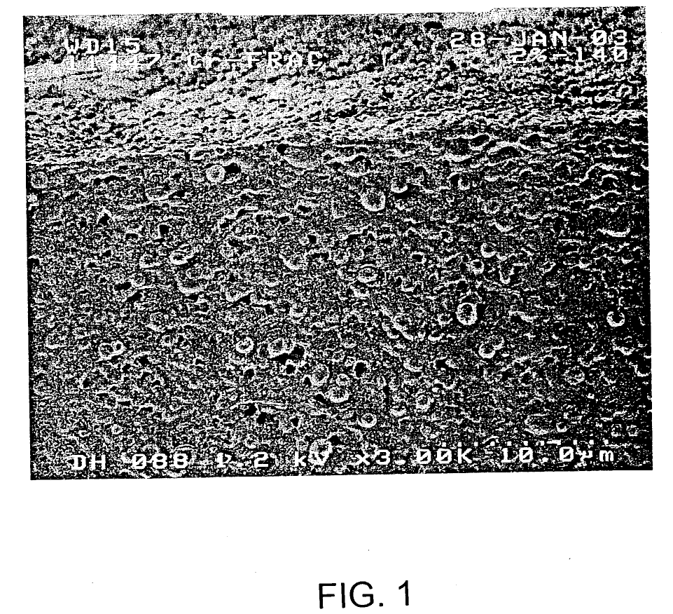

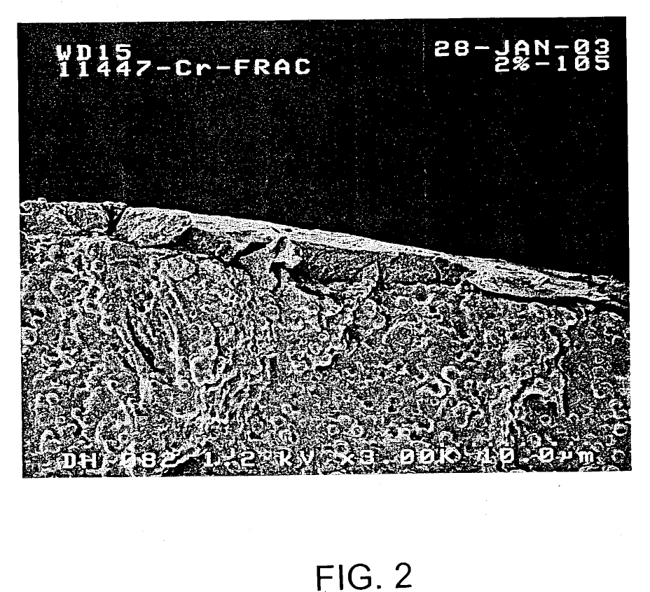

The method of the present invention generally includes providing a former on which the article is to be formed, coating the former with a coagulant composition containing zinc stearate, dipping the former into a polymer composition including an elastometic polymer and water, curing the elastomeric polymer at a temperature above the melting point of zinc stearate, and removing the water from the polymer composition on the former to form the elastomeric article. The melting point of the zinc stearate depends on the level of purity of the zinc stearate supplied, and generally ranges from about 118° C. to 128° C. By curing the elastomeric polymer at a temperature above the melting point of zinc stearate, the zinc stearate particles undergo a fusion process to permeate the outside surface, or gripping surface, of the article. The article is generally cured before the water is removed from the polymer composition on the former to maximize migration of the zinc stearate into the elastomeric polymer and to further secure the coating to the article. Thus, a permeated zinc stearate layer is formed (FIG. 1), providing a desirable decrease in tackiness that is more durable than coatings formed using traditional zinc stearate processing techniques, which generally result in a flaky, crust-like coating that is easily removed upon flexing of the article (FIG. 2).

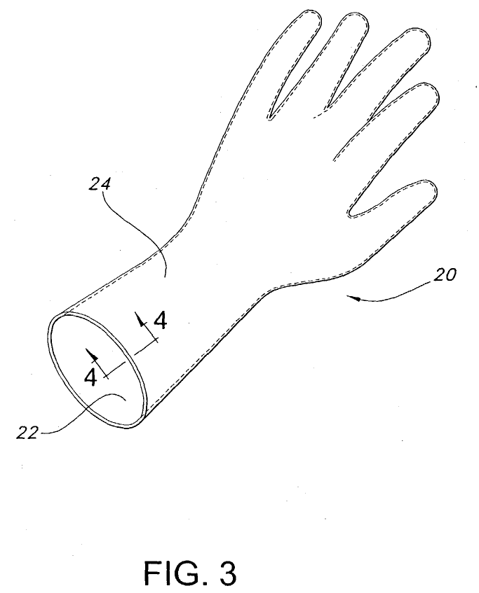

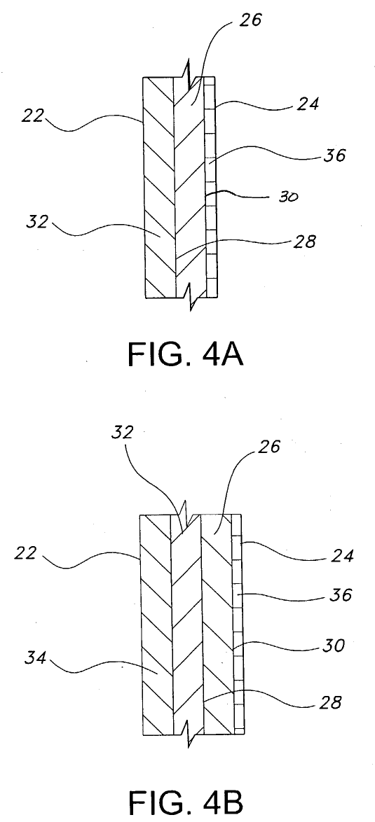

An article made according to the present invention, for example, a glove 20, generally includes an inside surface 22 and an outside surface 24 (FIG. 3). As used herein, the “inside surface” refers to the surface of the article that contacts the body of the wearer. As used herein, the “outside surface” refers to the surface of the article that is distal from the body of the wearer. The glove includes a substrate body 26 having a first surface 28 and a second surface 30 (FIG. 4A-4B). As used herein, “first surface” refers to the surface of the substrate body proximal to the body of the wearer. As used herein, “second surface” refers to the surface of the substrate body distal to the body of the wearer.

The article of the present invention may include a single layer or multiple layers as desired. In a single layer glove including only the substrate body, the first surface may form the inside surface of the glove. However, in a multi-layer glove having additional layers proximal the body of the wearer, the additional layer or layers may each form a portion of the inside surface, or the entire inside surface, as desired. Likewise, in a single layer glove including only the substrate body, the second surface may form the outside surface of the glove. However, in a multi-layer glove having additional layers distal from the body of the wearer, the additional layer or layers may each form a portion of the outside surface, or the entire outside surface, as desired.

For example, as depicted in FIG. 4A, the article may include a donning layer 32 overlying at least a portion of the first surface 28 of the substrate body 26. In such an article, the donning layer 32 forms at least a portion of the inside surface 22 of the glove 20. As depicted in FIG. 4B, the article may also include other layers, such as a lubricant layer 34 that overlies at least a portion of the donning layer 32. In such an article, the lubricant layer 34 forms at least a portion of the inside surface 22 of the glove 20. As depicted in FIGS. 4A-4B, the substrate body 26 may further include a fused zinc stearate coating 36 that is physically bound to the substrate body 26 and forms at least a portion of the outside surface 24 of the glove 20.

The article of the present invention may be formed using a variety of processes, for example, dipping, spraying, tumbling, drying, and curing. An exemplary dipping process for forming a glove is described herein, though other processes may be employed to form various articles having different shapes and characteristics. Furthermore, it should be understood that a batch, semi-batch, or a continuous process may be used with the present invention.

A glove is formed on a hand-shaped mold, termed a “former”. The former may be made from any suitable material, such as glass, metal, porcelain, or the like. The surface of the former defines at least a portion of the surface of the glove to be manufactured.

In general, the glove is formed by dipping the former into a series of compositions as needed to attain the desired glove characteristics. The glove may be allowed to solidify between layers. Any combination of layers may be used, and although specific layers are described herein, it should be understood that other layers and combinations of layers may be used as desired.

The glove former is first conveyed through a preheated oven to evaporate any water present from cleaning the former. The former is then dipped into a bath typically containing a coagulant, a powder source, a surfactant, and water. According to the present invention, the coagulant composition further includes zinc stearate. The zinc stearate may be present in any suitable amount, and in some instances, the zinc stearate is present in an amount of from about 0.5 mass % to about 8 mass % of the coagulant composition. In other instances, the zinc stearate is present in an amount of from about 0.75 mass % to about 6 mass % of the coagulant composition. In yet other instances, the zinc stearate is present in an amount of about 2 mass % of the coagulant composition. In still other instances, the zinc stearate is present in an amount of about 0.8 mass % of the coagulant composition.

The residual heat evaporates the water in the coagulant mixture leaving, for example, calcium nitrate, zinc stearate powder, and surfactant on the surface of the former. The surfactant provides enhanced wetting to avoid forming a meniscus and trapping air between the former and deposited latex, particularly in the cuff area.

The coated former is then dipped into a polymer composition containing an elastomeric polymer to form the substrate body 26 (FIGS. 4A-4B). The substrate body may be formed from any suitable elastomeric polymer, and in some embodiments, the substrate body may be formed from natural rubber, which is typically provided as a compounded natural rubber latex. In other embodiments, the elastomeric polymer may include nitrile butadiene rubber, and in particular, may include carboxylated nitrile butadiene rubber. In yet other embodiments, the elastomeric polymer may include synthetic isoprene. While articles formed from natural rubber are described in detail herein, it should be understood that any other suitable polymer or combination of polymers may be used with the present invention.

Thus, the polymer composition may contain various components, for example, compounded natural rubber latex, stabilizers, antioxidants, curing activators, organic accelerators, vulcanizers, and the like. The stabilizers may include phosphate-type surfactants. The antioxidants may be phenolic, for example, 2,2′-methylenebis (4-methyl-6-t-butylphenol). The curing activator may be zinc oxide. The organic accelerator may be dithiocarbamate. The vulcanizer may be sulfur or a sulfur-containing compound. To avoid crumb formation, the stabilizer, antioxidant, activator, accelerator, and vulcanizer may first be dispersed into water by using a ball mill and then combined with the natural rubber latex.

During the dipping process, the coagulant on the former causes some of the elastomeric polymer to become locally unstable and coagulate onto the surface of the former. The elastomeric polymer coalesces, capturing the particles present in the coagulant composition at the surface of the coagulating elastomeric polymer. The former is withdrawn from the polymer composition and the coagulated layer is permitted to fully coalesce, thereby forming the substrate body. The former is dipped into one or polymer compositions a sufficient number of times to attain the desired glove thickness. In some embodiments, the substrate body may have a thickness of from about 0.004 inches to about 0.012 inches.

The former is then dipped into a leaching tank in which hot water is circulated to remove the water-soluble components, such as residual calcium nitrates and proteins contained in the natural rubber latex. This leaching process may generally continue for about twelve minutes at a water temperature of about 120° F. The glove is then dried on the former to solidify and stabilize the substrate body. It should be understood that various conditions, process, and materials may be used to form the substrate body. Furthermore, other layers may be formed by including additional dipping processes. Such layers may be used to impart additional attributes to the glove.

Where desired, the former may then be dipped into a composition to form a donning layer 32 over at least a portion of the first surface 28 of the substrate body 26 to facilitate donning of the glove 20 (FIGS. 3-4B). In one embodiment, the donning layer may generally include a modified vinyl acetate polymer. In some embodiments, the vinyl acetate polymer may be silicone-modified. As used herein, the term “silicone” generally refers to a broad family of synthetic polymers that have a repeating silicon-oxygen backbone, including, but not limited to, polydimethylsiloxane and polysiloxanes having hydrogen-bonding functional groups selected from the group consisting of amino, carboxyl, hydroxyl, ether, polyether, aldehyde, ketone, amide, ester, and thiol groups. The silicone-modified vinyl acetate polymer may include any suitable silicon content, and in some instances, the silicone-modified vinyl acetate polymer may include from about 10 atomic % to about 30 atomic % silicon. In other instances, the silicone-modified vinyl acetate polymer may include from about 15 atomic % to about 25 atomic % silicon. In yet other instances, the silicone-modified vinyl acetate polymer may include from about 17 atomic % to about 22 atomic % silicon. In one such embodiment, the silicone-modified vinyl acetate polymer may include about 17.7 atomic % silicon. In another such embodiment, the silicone-modified vinyl acetate polymer may include about 21.8 atomic % silicon.

One such modified vinyl acetate polymer that may be suitable for use with the present invention is commercially available from Reichhold Chemicals, Inc. (Research Triangle Park, North Carolina) under the trade name SYNTHEMUL® 97907-00 synthetic resin emulsion. SYNTHEMUL® 97907-00 synthetic resin emulsion is believed to be a carboxylated vinyl acetate latex that contains about 46 mass % modified vinyl acetate polymer, about 56 mass % water, and small amounts of vinyl acetate monomer. Another modified vinyl acetate polymer that may be suitable for use with the present invention is also commercially available from Reichhold Chemicals, Inc. (Research Triangle Park, North Carolina) under the trade name SYNTHEMUL® 97635-00 synthetic resin emulsion. SYNTHEMUL® 97635-00 synthetic resin emulsion is believed to be a vinyl acetate homopolymer that contains about 46 mass % vinyl acetate homopolymer, about 56 mass % water, and small amounts of vinyl acetate monomer. While exemplary modified vinyl acetate polymers are set forth herein, it should be understood that any suitable modified vinyl acetate polymer may be used with the present invention.

Furthermore, it should be understood that other polymeric materials may be used to form the donning layer with the present invention. Examples of such materials that may be suitable include polybutadienes, hydrogel polymers, polyurethanes, and acrylic polymers.

The donning layer may be present in the finished elastomeric article any suitable amount, and in some embodiments, the donning layer may be present in an amount of from about 0.1% mass % to about 2.5 mass % of the elastomeric article. In other embodiments, the donning layer may be present in an amount of from about 0.25 mass % to about 1.5 mass % of the elastomeric article. In yet other embodiments, the donning layer may be present in an amount of about 0.5 mass % of the elastomeric article.

When the former is withdrawn from the composition, the substrate body coated with the donning layer composition is then sent to a curing station where the elastomeric polymer is exposed to a heat source, typically an oven. The accelerator and vulcanizer contained in the latex coating of the former are used to crosslink the natural rubber. The vulcanizer forms sulfur bridges between different rubber segments and the accelerator is used to promote rapid sulfur bridge formation.

In accordance with the present invention, the oven may be divided into various temperature zones with a former being conveyed through zones of generally decreasing temperature. It has been discovered that by subjecting the coated former to a temperature above the melting point of the zinc stearate, the zinc stearate migrates into the materials on the former to form a durable, efficacious coating on the surface of the glove. Furthermore, it has been discovered that subjecting the former to a temperature greater than the melting point of zinc stearate before the residual water is removed enables the zinc stearate to migrate into the materials on the former (i.e., the polymer composition and donning layer composition), thereby further increasing the durability of the coating as it fuses. Thus, the residual water is removed during one or more heating steps after the zinc stearate permeates the surface of the materials on the former. Thus, for example, in one embodiment, the first temperature zone may be maintained a temperature of from about 120° C. to about 150° C. to fuse the zinc stearate and allow it to migrate into the materials on the former, and the second temperature zone may be maintained at a temperature of from about 100° C. to about 119° C. to evaporate the residual water from the materials on the former.

In another embodiment, the former may be advanced through more than two temperature zones. For instance, the former may advance through a first temperature zone maintained at from about 120° C. to about 150° C., a second temperature zone maintained at from about 111° C. to about 119° C., and a third temperature zone maintained at from about 105° C. to about 115° C. It should be understood that while exemplary zones and temperatures thereof are set forth herein, the actual number of zones and temperatures thereof may depend on the type of elastomeric polymer used, the accelerator selected, the size of the oven and the residence time of the former therein, and so forth.

When all of the desired polymer layers have been formed and the glove is solidified, the former may be transferred to a stripping station where the glove is removed from the former. The presence of the zinc stearate coating on the surface of the glove in contact with the former facilitates release of the glove from the former. The stripping station may involve automatic or manual removal of the glove from the former. For example, in one embodiment, the glove is manually removed and turned inside out as it is stripped from the former. In such an instance, the zinc stearate forms the outside surface of the article that is distal from the wearer.

The solidified glove may then undergo to various post-formation processes. In some instances, the glove may be inverted as needed to expose the donning layer for halogenation. The halogenation (e.g., chlorination) may be performed in any suitable manner known to those skilled in the art. Chlorination generally entails contacting the surface to be chlorinated to a source of chlorine. Such methods include: (1) direct injection of chlorine gas into a water mixture, (2) mixing high density bleaching powder and aluminum chloride in water, (3) brine electrolysis to produce chlorinated water, and (4) acidified bleach. Examples of such methods are described in U.S. Pat. No. 3,411,982 to Kavalir; U.S. Pat. No. 3,740,262 to Agostinelli; U.S. Pat. No. 3,992,221 to Homsy, et al.; U.S. Pat. No. 4,597,108 to Momose; and U.S. Pat. No. 4,851,266 to Momose, U.S. Pat. No. 5,792,531 to Littleton, et al., which are incorporated herein in their entirety by reference. In one embodiment, for example, chlorine gas is injected into a water stream and then fed into a chlorinator (a closed vessel) containing the glove. The concentration of chlorine can be altered to control the degree of chlorination. The chlorine concentration is typically at least about 100 parts per mllion (ppm), in some embodiments from about 200 ppm to about 3500 ppm, and in some embodiments, from about 300 ppm to about 600 ppm, for example, about 400 ppm. The duration of the chlorination step may also be controlled to vary the degree of chlorination and may range, for example, from about 1 to about 10 minutes, for example, 4 minutes.

Still within the chlorinator, the chlorinated glove may then be rinsed with tap water at about room temperature. This rinse cycle may be repeated as necessary. Once all water is removed, the glove is tumbled to drain the excess water.

Where desired, a lubricant composition may then be added into the chlorinator and tumbled for about five minutes. The lubricant forms a lubricant layer 34 over at least a portion of the donning layer 32 to further facilitate donning of the glove 20 (FIGS. 3 and 4B). Any suitable lubricant may be used with the present invention as described herein.

In one embodiment, the lubricant layer may contain a silicone or silicone-based component. In some embodiments, polydimethylsiloxane and/or modified polysiloxanes may be used as the silicone component in accordance with the present invention. For instance, some suitable modified polysiloxanes that can be used in the present invention include, but are not limited to, phenyl-modified polysiloxanes, vinyl-modified polysiloxanes, methyl-modified polysiloxanes, fluoro-modified polysiloxanes, alkyl-modified polysiloxanes, alkoxy-modified polysiloxanes, amino-modified polysiloxanes, and combinations thereof.

In some embodiments, the lubricant layer may include a silicone emulsion. One such silicone emulsion that may be suitable for use with the present invention is DC 365, a pre-emulsified silicone (35% TSC) that is commercially available from Dow Corning Corporation (Midland, Mich.). DC 365 is believed to contain 40-70 mass % water (aqueous solvent), 30-60 mass % methyl-modified polydimethylsiloxane (silicone), 1-5 mass % propylene glycol (non-aqueous solvent), 1-5 mass % polyethylene glycol sorbitan monolaurate (nonionic surfactant), and 1-5 mass % octylphenoxy polyethoxy ethanol (nonionic surfactant). Another silicone emulsion that may be suitable for use with the present invention is SM 2140, commercially available from GE Silicones (Waterford, N.Y.). SM 2140 is a pre-emulsified silicone (50% TSC) that is believed to contain 30-60 mass % water (aqueous solvent), 30-60 mass % amino-modified polydimethylsiloxane (silicone), 1-5% ethoxylated nonyl phenol (nonionic surfactant), 1-5 mass % trimethyl-4-nonyloxypolyethyleneoxy ethanol (nonionic surfactant), and minor percentages of acetaldehyde, formaldehyde, and 1,4 dioxane. Another silicone emulsion that may be suitable for use with the present invention is SM 2169 available from GE Silicones (Waterford, N.Y.). SM 2169 is a pre-emulsified silicone that is believed to contain 30-60 mass % water, 60-80 mass % polydimethylsiloxane, 1-5 mass % polyoxyethylene lauryl ether, and a small amount of formaldehyde. Yet another silicone that may be suitable for use with the present invention is commercially available from GE Silicones (Waterford, N.Y.) under the trade name AF-60. AF-60 is believed to contain polydimethylsiloxane, acetylaldehyde, and small percentages of emulsifiers. If desired, these pre-emulsified silicones may be diluted with water or other solvents prior to use.

In another embodiment, the lubricant layer may contain a quaternary ammonium compound, such as that commercially available from Goldschmidt Chemical Corporation of Dublin, Ohio under the trade name VERISOFT® BTMS. VERISOFT® BTMS is believed to contain behnyl trimethyl sulfate and cetyl alcohol. Thus for example, in one embodiment, the lubricant layer includes a quaternary ammonium compound such as VERISOFT® BTMS and a silicone emulsion such as SM 2169.

In other embodiments, the lubricant layer may include, for example, a cationic surfactant (e.g., cetyl pyridinium chloride), an anionic surfactant (e.g., sodium lauryl sulfate), a noruonic surfactant, or the like.

In some embodiments, one or more cationic surfactants may be used. Examples of cationic surfactants that may be suitable for use with the present invention include, for example, behenetrimonium methosulfate, distearyldimonium chloride, dimethyl dioctadecyl ammonium chloride, cetylpyridinium chloride, methylbenzethonium chloride, hexadecylpyridinium chloride, hexadecyltrimethylammonium chloride, benzalkonium chloride, dodecylpyridinium chloride, the corresponding bromides, hydroxyethylheptadecylimidazolium halides, coco aminopropyl betaine, and coconut alkyldimethylammonium betaine. Additional cationic surfactants that may be used include methyl bis(hydrogenated tallow amidoethyl)-2-hydroxyethly ammonium methyl sulfate, methyl bis(tallowamido ethyl)-2-hydroxyethyl ammonium methyl sulfate, methyl bis(soya amidoethyl)-2-hydroxyethyl ammonium methyl sulfate, methyl bis(canola amidoethyl)-2-hydroxyethyl ammonium methyl sulfate, methyl bis(tallowamido ethyl)-2-tallow imidazolinium methyl sulfate, methyl bis(hydrogenated tallowamido ethyl)-2-hydrogenated tallow imidazolinium methyl sulfate, methyl bis(ethyl tallowate)-2-hydroxyethyl ammonium methyl sulfate, methyl bis(ethyl tallowate)-2-hydroxyethyl ammonium methyl sulfate, dihydrogenated tallow dimethyl ammonium chloride, didecyl dimethyl ammonium chloride, dioctyl dimethyl ammonium chloride, octyl decyl dimethyl ammonium chloride diamidoamine ethoxylates, diamidoaamine imidazolines, and quaternary ester salts.

In some embodiments, one or more nonionic surfactants may be used. Nonionic surfactants typically have a hydrophobic base, such as a long chain alkyl group or an alkylated aryl group, and a hydrophilic chain comprising a certain number (e.g., 1 to about 30) of ethoxy and/or propoxy moieties. Examples of some classes of nomionic surfactants that may be used include, but are not limited to, ethoxylated alkylphenols, ethoxylated and propoxylated fatty alcohols, polyethylene glycol ethers of methyl glucose, polyethylene glycol ethers of sorbitol, ethylene oxide-propylene oxide block copolymers, ethoxylated esters of fatty (C₈-C₁₈) acids, condensation products of ethylene oxide with long chain anunes or amides, condensation products of ethylene oxide with alcohols, and mixtures thereof.

Specific examples of suitable nonionic surfactants include, but are not limited to, methyl gluceth-10, PEG-20 methyl glucose distearate, PEG-20 methyl glucose sesquistearate, C₁₁₋₁₅ pareth-20, ceteth-8, ceteth-12, dodoxynol-12, laureth-15, PEG-20 castor oil, polysorbate 20, steareth-20, polyoxyethylene-10 cetyl ether, polyoxyethylene-10 stearyl ether, polyoxyethylene-20 cetyl ether, polyoxyethylene-10 oleyl ether, polyoxyethylene-20 oleyl ether, an ethoxylated nonylphenol, ethoxylated octylphenol, ethoxylated dodecylphenol, or ethoxylated fatty (C₆-C₂₂ alcohol, including 3 to 20 ethylene oxide moieties, polyoxyethylene-20 isohexadecyl ether, polyoxyethylene-23 glycerol laurate, polyoxy-ethylene-20 glyceryl stearate, PPG-10 methyl glucose ether, PPG-20 methyl glucose ether, polyoxyethylene-20 sorbitan monoesters, polyoxyethylene-80 castor oil, polyoxyethylene-15 tridecyl ether, polyoxy-ethylene-6 tridecyl ether, laureth-2, laureth-3, laureth-4, PEG-3 castor oil, PEG 600 dioleate, PEG 400 dioleate, oxyethanol, 2,6,8-trimethyl-4-nonyloxypolyethylene oxyethanol; octylphenoxy polyethoxy ethanol, nonylphenoxy polyethoxy ethanol, 2,6,8-trimethyl-4-nonyloxypolyethylene alkyleneoxypolyethyleneoxyethanol, alkyleneoxypolyethyleneoxyethanol, alkyleneoxypolyethyleneoxyethanol, and mixtures thereof.

Additional nonionic surfactants that may be used include water soluble alcohol ethylene oxide condensates that are the condensation products of a secondary aliphatic alcohol containing between about 8 to about 18 carbon atoms in a straight or branched chain configuration condensed with between about 5 to about 30 moles of ethylene oxide. Such nonionic surfactants are commercially available under the trade name TERGITOL® from Union Carbide Corp. (Danbury, Conn.). Specific examples of such commercially available nonionic surfactants of the foregoing type are C₁₁-C₁₅ secondary alkanols condensed with either 9 moles of ethylene oxide (TERGITOL® 15-S-9) or 12 moles of ethylene oxide (TERGITOL® 15-S-12) marketed by Union Carbide Corp. (Danbury, Conn.).

Other suitable nonionic surfactants include the polyethylene oxide condensates of one mole of alkyl phenol containing from about 8 to 18 carbon atoms in a straight- or branched chain alkyl group with about 5 to 30 moles of ethylene oxide. Specific examples of alkyl phenol ethoxylates include nonyl condensed with about 9.5 moles of ethylene oxide per mole of nonyl phenol, dinonyl phenol condensed with about 12 moles of ethylene oxide per mole of phenol, dinonyl phenol condensed with about 15 moles of ethylene oxide per mole of phenol and diisoctylphenol condensed with about 15 moles of ethylene oxide per mole of phenol. Commercially available nonionic surfactants of this type include IGEPAL® CO-630 (a nonyl phenol ethoxylate) marketed by ISP Corp. (Wayne, N.J.). Suitable non-ionic ethoxylated octyl and nonyl phenols include those having from about 7 to about 13 ethoxy units.

In some embodiments, one or more amphoteric surfactants may be used. One class of amphoteric surfactants that may suitable for use with the present invention includes the derivatives of secondary and tertiary amines having aliphatic radicals that are straight chain or branched, where one of the aliphatic substituents contains from about 8 to 18 carbon atoms and at least one of the aliphatic substituents contains an anionic water-solubilizing group, such as a carboxy, sulfonate, or sulfate group. Some examples of amphoteric surfactants include, but are not limited to, sodium 3-(dodecylamino)propionate, sodium 3-(dodecylamino)-propane-1-sulfonate, sodium 2-(dodecylamnino)ethyl sulfate, sodium 2-(dimethylamino)octadecanoate, disodium 3-(N-carboxymethyl-dodecylamino)propane-1-sulfonate, sodium 1-carboxymethyl-2-undecylimidazole, disodium octadecyliminodiacetate, and sodium N, N-bis(2-hydroxyethyl)-2-sulfato-3-dodecoxypropylamine.

Additional classes of suitable amphoteric surfactants include phosphobetaines and phosphitaines. For instance, some examples of such amphoteric surfactants include, but are not limited to, sodium coconut N-methyl taurate, sodium oleyl N-methyl taurate, sodium tall oil acid N-methyl taurate, cocodimethylcarboxymethylbetaine, lauryldimethylcarboxymethylbetaine, lauryldimethylcarboxyethylbetaine, cetyldimethylcarboxymethylbetaine, sodium palmitoyl N-methyl taurate, oleyldimethylgammacarboxypropylbetaine, lauryl-bis-(2-hydroxypropyl)-carboxyethylbetaine, di-sodium oleamide PEG-2 sulfosuccinate, laurylamido-bis-(2-hydroxyethyl) propylsultaine, lauryl-bis-(2-hydroxyethyl) carboxymethylbetaine, cocoamidodimethylpropylsultaine, stearylamidodimethylpropylsultaine, TEA oleamido PEG-2 sulfosuccinate, disodium oleamide MEA sulfosuccinate, disodium oleamide MIPA sulfosuccinate, disodium ricinoleamide MEA sulfosuccinate, disodium undecylenamide MEA sulfosuccinate, disodium wheat germamido MEA sulfosuccinate, disodium wheat germamido PEG-2 sulfosuccinate, disodium isostearamideo MEA sulfosuccinate, cocoamido propyl monosodium phosphitaine, lauric myristic amido propyl monosodium phosphitaine, cocoamido disodium 3-hydroxypropyl phosphobetaine, lauric myristic amido disodium 3-hydroxypropyl phosphobetaine, lauric myristic amido glyceryl phosphobetaine, lauric myristic amido carboxy disodium 3-hydroxypropyl phosphobetaine, cocoamphoglycinate, cocoamphocarboxyglycinate, capryloamphocarboxyglycinate, lauroamphocarboxyglycinate, lauroamphoglycinate, capryloamphocarboxypropionate, lauroamphocarboxypropionate, cocoamphopropionate, cocoamphocarboxypropionate, dihydroxyethyl tallow glycinate, and mixtures thereof.

In certain instances, one or more anionic surfactants may be used. Suitable anionic surfactants include, but are not limited to, alkyl sulfates, alkyl ether sulfates, alkyl ether sulfonates, sulfate esters of an alkylphenoxy polyoxyethylene ethanol, alpha-olefin sulfonates, beta-alkoxy alkane sulfonates, alkylauryl sulfonates, alkyl monoglyceride sulfates, alkyl monoglyceride sulfonates, alkyl carbonates, alkyl ether carboxylates, fatty acids, sulfosuccinates, sarcosinates, octoxynol or nonoxynol phosphates, taurates, fatty taurides, fatty acid amide polyoxyethylene sulfates, isethionates, or mixtures thereof.

Particular examples of some suitable anionic surfactants include, but are not limited to, C₈-C₁₈ alkyl sulfates, C₈-C₁₈ fatty acid salts, C₈-C₁₈ alkyl ether sulfates having one or two moles of ethoxylation, C₈-C₁₈ alkamine oxides, C₈-C₁₈ alkoyl sarcosinates, C₈-C₁₈ sulfoacetates, C₈-C₁₈ sulfosuccinates, C₈-C₁₈ alkyl diphenyl oxide disulfonates, C₈-C₁₈ alkyl carbonates, C₈-C₁₈ alpha-olefin sulfonates, methyl ester sulfonates, and blends thereof. The C₈-C₁₈ alkyl group may be straight chain (e.g., lauryl) or branched (e.g., 2-ethylhexyl). The cation of the anionic surfactant may be an alkali metal (e.g., sodium or potassium), ammonium, C₁-C₄ alkylammonium (e.g., mono-, di-, tri), or C₁-C₃ alkanolammonium (e.g., mono-, di-, tri).

Specific examples of such anionic surfactants include, but are not limited to, lauryl sulfates, octyl sulfates, 2-ethylhexyl sulfates, lauramine oxide, decyl sulfates, tridecyl sulfates, cocoates, lauroyl sarcosinates, lauryl sulfosuccinates, linear C₁₀ diphenyl oxide disulfonates, lauryl sulfosuccinates, lauryl ether sulfates (1 and 2 moles ethylene oxide), myristyl sulfates, oleates, stearates, tallates, ricinoleates, cetyl sulfates, and so forth.

The lubricant solution is then drained from the chlorinator and may be reused if desired. It should be understood that the lubricant composition may be applied at a later stage in the forming process, and may be applied using any technique, such as dipping, spraying, immersion, printing, tumbling, or the like. The coated glove is then put into a drier and dried for about 10 to 60 minutes (e.g., 40 minutes) at from about 20° C. to about 80° C. (e.g., 40° C.) to dry the inside surface of the glove. The glove is then inverted and the outside surface may be dried for about 20 to 100 minutes (e.g., 60 minutes) at from about 20° C. to about 80° C. (e.g., 40° C.).

These discoveries are evidenced by the following examples, which are not intended to be limiting in any manner.

### EXAMPLE 1

Two sets of gloves samples were prepared to determine the effect of processing temperature on the resulting glove. The control gloves were formed using traditional techniques, while the experimental gloves were formed according to the method of the present invention.

The formers were first cleaned and dried. The formers were then dipped into a coagulant composition containing about 6 mass % Diptack AN zinc stearate particles (commercially available from MG Chemical Trading, SDN BHD), about 16.25 mass % calcium nitrate, and small percentages of surfactants in water. The formers were then dipped into an elastomeric polymer composition to form the substrate body of the glove. The elastomeric polymer composition included about 30 mass % high ammonia natural rubber latex. The formers were then dipped in water to leach excess proteins and chemicals, and exposed to air to dry the substrate body.

The formers were then placed in an oven to cure the natural rubber. The control gloves were placed in an oven maintained at about 105° C. for about 20 minutes. The experimental gloves were placed in an oven maintained at about 140° C. for about 20 minutes.

The gloves were then stripped from the formers. The control gloves released readily from the formers. However, the zinc stearate powder was easily removed from the surface of the glove, thereby increasing the surface tackiness. The experimental gloves also released readily from the formers. However, the zinc stearate remained affixed to the surface of the glove, thereby maintaining the desired decrease in surface tackiness.

### EXAMPLE 2

Gloves were formed according to the present invention. Several hundred formers were cleaned, dried, and dipped into a coagulant composition including about 16.25 mass % calcium nitrate, about 2 mass % Diptack AN zinc stearate particles (commercially available from MG Chemical Trading, SDN BHD), and about 2 mass % surfactant in water. The coagulant on each former was then dried for about 35 seconds at a temperature of about 105° C., and then for about 35 seconds at a temperature of about 75° C.

The formers were then dipped into a 30 mass % high ammonia natural rubber latex composition to form the substrate body of each glove. The formers were then exposed to air to permit the elastomeric polymer to form a film on the surface of each former. The formers were exposed to air at a temperature of about 105° C. for about 65 seconds, then to air at a temperature of about 110° C. for about 35 seconds.

The substrate body on the former was then leached in circulating water at a temperature of about 45° C. for about 2 minutes to remove any residual proteins and coagulant chemicals.

After forming the substrate body, the formers were then dipped into a composition to form the donning layer. The composition included about 2 mass % SYNTHEMUL® 97907-00 silicone-modified vinyl acetate polymer in deionized water.

Each former was then sent to a bead rolling station where a bead was formed on the cuff of each glove. The polymer on the formers was then dried for about 67 seconds at a temperature of about 110° C.

The formers were then sent to a curing station having multiple temperature zones to vulcanize and solidify the natural rubber substrate body and the donning layer. The formers were advanced through an oven having a first temperature zone maintained at about 130° C., a second temperature zone maintained at about 115° C., and a third temperature zone maintained at about 110° C. The total amount of time required to cure the article was about 30 minutes.

The gloves still on the formers were then leached in circulating water at a temperature of about 40° C. for about 2 minutes to remove residual proteins and chemicals. The gloves were then dried for about 67 seconds at a temperature of 110° C. and stripped from the formers. The gloves stripped readily from the formers.

The gloves were then manipulated to determine the efficacy and the durability of the zinc stearate coating on the outside surface of the glove. The presence of the zinc stearate sufficiently reduced the tackiness of the outside surface. Furthermore, the zinc stearate did not flake off of the article onto the hands or clothing of the wearer.

This invention may be embodied in other specific forms without departing from the scope and spirit of the inventive characteristics thereof. The present embodiments therefore are to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A method of forming an elastomeric article comprising:
(a) providing a former;
(b) coating the former with a coagulant composition, the coagulant composition comprising zinc stearate;
(c) dipping the former into a polymer composition comprising an elastomeric polymer and water,
(d) curing the elastomeric polymer at a temperature above the melting point of the zinc stearate; and
(e) removing the water from the polymer composition on the former to form the elastomeric article.

2. The method of claim 1, wherein the zinc stearate is present in the coagulant composition in an amount of from about 0.5 mass % to about 8 mass % of the coagulant composition.

3. The method of claim 1, wherein the zinc stearate is present in the coagulant composition in an amount of from about 0.75 mass % to about 6 mass % of the coagulant composition.

4. The method of claim 1, wherein the zinc stearate is present in the coagulant composition in an amount of about 2 mass % of the coagulant composition.

5. The method of claim 1, wherein the zinc stearate is present in the coagulant composition in an amount of about 0.8 mass % of the coagulant composition.

6. The method of claim 1, wherein the step of coating comprises dipping the former into the coagulant composition.

7. The method of claim 1, wherein the elastomeric polymer comprises natural rubber.

8. The method of claim 1, wherein the elastomeric polymer comprises a nitrile butadiene rubber.

9. The method of claim 1, wherein the elastomeric polymer comprises synthetic polyisoprene rubber.

10. A method of forming an elastomeric article having reduced tack comprising:
(a) providing a former;
(b) coating the former with a coagulant composition, the coagulant composition comprising zinc stearate;
(c) dipping the former into a polymer composition comprising an elastomeric polymer and water;
(d) curing the elastomeric polymer, wherein curing the elastomeric polymer comprises exposing the elastomeric polymer to a heat source having a first temperature zone maintained at a temperature of from about 120° C. to about 150° C., and a second temperature zone maintained at a temperature of from about 100° C. to about 119° C.; and
(e) removing the water from the polymer composition on the former to form the elastomeric article.

11. The method of claim 10, wherein the zinc stearate is present in the coagulant composition in an amount of from about 0.5 mass % to about 8 mass % of the coagulant composition.

12. The method of claim 10, wherein the zinc stearate is present in the coagulant composition in an amount of about 2 mass % of the coagulant composition.

13. The method of claim 10, wherein the zinc stearate is present in the coagulant composition in an amount of about 0.8 mass % of the coagulant composition.

14. The method of claim 10, wherein the elastomeric polymer comprises natural rubber.

15. The method of claim 10, wherein the elastomeric polymer comprises a nitrile butadiene rubber.

16. The method of claim 10, wherein the elastomeric polymer comprises synthetic polyisoprene rubber.

17. The method of claim 10, wherein the step of coating comprises dipping the former into the coagulant composition.

18. A method of forming an elastomeric article having improved release characteristics:
(a) providing a former;
(b) coating the former with a coagulant composition, the coagulant composition comprising from about 0.5 mass % to about 8 mass % zinc stearate;
(c) dipping the former into a polymer composition comprising an elastomeric polymer and water;
(d) curing the elastomeric polymer, wherein curing the elastomeric polymer comprises exposing the elastomeric polymer to a heat source having a first temperature zone maintained at from about 120° C. to about 150° C., a second temperature zone maintained at from about 111° C. to about 119° C., and a third temperature zone maintained at from about 105° C. to about 115° C.;
(e) removing the water from the polymer composition on the former to form the elastomeric article; and
(f) stripping the elastomeric article from the former.

19. An elastomeric article formed by the method comprising:
(a) providing a former;
(b) coating the former with a coagulant composition, the coagulant composition comprising about 0.8 mass % zinc stearate;
(c) dipping the former into a polymer composition comprising a nitrile butadiene rubber and water;
(d) curing the nitrile butadiene rubber at a temperature above the melting point of the zinc stearate; and
(e) removing the water from the polymer composition on the former to form the elastomeric article.

20. An elastomeric article formed by the method comprising:
(a) providing a former;
(b) coating the former with a coagulant composition, the coagulant composition comprising about 2 mass % zinc stearate;
(c) dipping the former into a polymer composition comprising natural rubber and water;
(d) curing the natural rubber, wherein curing the natural rubber comprises exposing the natural rubber to a heat source having a first temperature zone maintained at a temperature of from about 120° C. to about 150° C., and a second temperature zone maintained at a temperature of from about 100° C. to about 119° C.; and
(e) removing the water from the polymer composition on the former to form the elastomeric article.
